(19) United States
(12) Patent Application Publication
(10) Pub. No.: US 2009/0030724 A1
(43) Pub. Date: Jan. 29, 2009

(54) System for providing hygienic education information and method thereof

(76) Inventor: William Pan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,967

(22) Filed: Mar. 26, 2008

(30) Foreign Application Priority Data
Jul. 23, 2007 (TW) 96126793

(51) Int. Cl. G06Q 50/00

(52) U.S. Cl. 705/2

(57) ABSTRACT

A method for providing hygienic education information comprising the steps of: receiving at least one set of diagnostic data, and defining an illness grade according to the diagnostic data; and then searching a hygienic education database based on the illness grade, and catching and outputting the hygienic education information corresponding to the illness grade in the hygienic education database. Hence, the present invention can find out the related hygienic education information according to the diagnosis result and the test data, and can provide effectively, practically, and accurately hygienic education information for the patient.

### BACKGROUND OF THE INVENTION

1. Field of the Invention

The present invention relates to a system for providing hygienic education information and the method thereof and, more particularly, to a system for providing related hygienic education information according to the diagnosis of patient and the method thereof.

2. Description of Related Art

With the establishment of health care services, progress of medical technology, and modernization of hospitals, patients can seek medical advice more conveniently than before and can obtain good diagnoses and care, and the relationship between patient and medical doctor has also been improved.

Moreover, the combination of modern medical apparatuses, equipment and high-precision technology enhances medical techniques and the capability to carry out precise diagnoses. Medical doctors can easily and quickly search and gather medical information in medical databases and use those as the basis for diagnosis and treatment so that they can get an accurate picture of patients' conditions and symptoms which enhances the accuracy of clinical diagnosis as well as the efficiency of medical treatment.

Therefore, both medical doctors and patients can comprehend the illness condition, and doctors can match the treatment to the illness. In order to cure a patient's illness, in addition to drug control, it is also important to improve everyday habits of the patient and to exclude potential pathogenic factors. Usually, a patient can get medical advice only while visiting a medical practitioner. After returning home, he or she may ignore a variation of the illness condition because of lack of knowledge about how to deal with the new symptoms, leading to the deterioration of his or her health.

In order to enable patients to understand and thus care for different illness conditions, special hygienic education information web sites are usually provided enabling patients to conveniently browse information from various medical units. However, a lot of drawbacks and inconvenience still exist in those systems. For instance, they only provide common hygienic education information, but are short of providing services for individual illness conditions or special demands of patients.

### SUMMARY OF THE INVENTION

An object of the present invention is to provide a system for providing hygienic education information and the method thereof, whereby through the installation of a faultless hygienic education database including reports, test data and clinical diagnoses, hygienic education information can be retrieved that is exactly relevant to the patient's health condition. The system will thus provide accurate, effective, practical, and personalized hygienic education information.

To achieve the above object, the present invention provides a system for providing hygienic education information, which comprises at least one data input unit, a hygienic education database, and a search and comparison unit. The data input unit is used to receive at least one set of diagnostic data. The hygienic education database is used to store various kinds of hygienic education information. The search and comparison unit is connected to the data input unit and the hygienic education database, and is used to search the hygienic education database according to an illness grade of the diagnostic data and then list hygienic education information correspondingly.

To achieve the above object, the present invention also provides a method for providing hygienic education information, which comprises the steps of: receiving at least one set of diagnostic data; distinguishing an illness grade corresponding to the diagnostic data; searching a hygienic education database based on the illness grade; and outputting hygienic education information corresponding to the illness grade in the hygienic education database. Thereby, the present invention can precisely provide hygienic education information required by a patient according to the medical diagnosis and/or the patient's test data.

### BRIEF DESCRIPTION OF THE DRAWINGS

The various objects and advantages of the present invention will be more readily understood from the following detailed description when read in conjunction with the appended drawings, in which:

FIG. 1 is a block diagram of a system for providing hygienic education information according to an embodiment of the present invention; and

FIG. 2 is a flowchart of a method for providing hygienic education information according to an embodiment of the present invention.

### DETAILED DESCRIPTION OF THE PREFERRED EMBODIMENTS

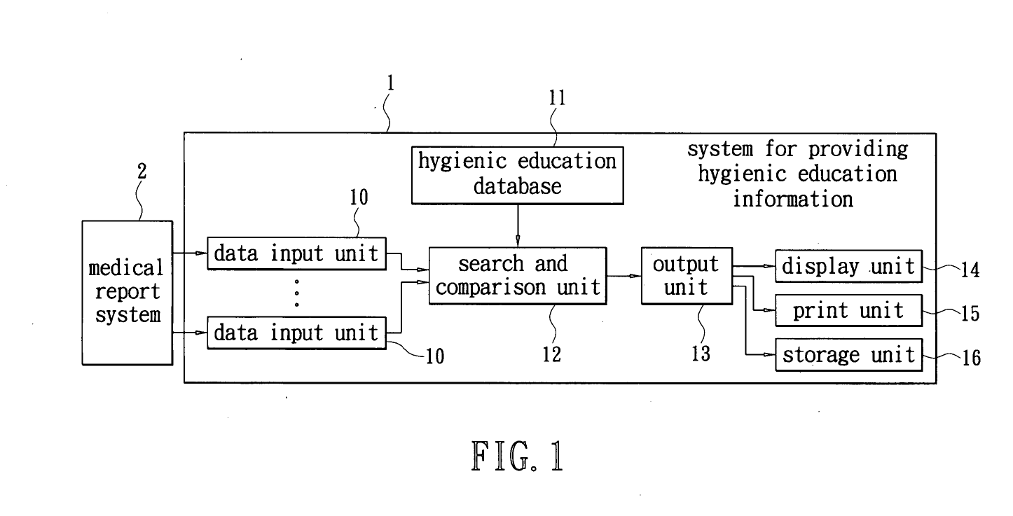

FIG. 1 is a block diagram of a system for providing hygienic education information according to an embodiment of the present invention. As shown in FIG. 1, the present invention provides a system 1 for providing hygienic education information, which comprises at least one data input unit 10, a hygienic education database 11, a search and comparison unit 12, an output unit 13, a display unit 14, a print unit 15 and a storage unit 16. The data input unit 10 is usually used to receive one set of diagnostic data. The diagnostic data can be either a personal diagnosis of a patient's illness condition by a medical doctor and/or a diagnosis made by the doctor based on test data of the patient taken by a medical apparatus. Additional information can be added by a medical doctor in the personal diagnosis of a patient's illness condition to specify different illness or illness grades. The data input unit 10 will convert the diagnostic data to a format suitable for the system 1 for providing hygienic education information to match the format required by the search and comparison unit 12.

In addition to receiving diagnostic data, the data input unit 10 can be connected to a medical report system 2 to receive consultations data and/or test data generated by the medical report system 2 with respect to the patient's health condition. Similarly, the medical doctor examines and analyzes the consultations data and/or the test data to make a diagnosis that forms the diagnostic data.

The hygienic education database 11 stores information of illustrations and diagnosis suggestions from doctors of different medical departments. The information in the hygienic education database 11 takes into account different parameters and different regions of origin of test data in order to correspond to the parameters set by medical doctors. That is, different illnesses, different orders of severity of illness and even different regions where the test data has been collected produce different symptoms, and the suggestions from medical doctors from different departments also differ. Thus, the classification of information stored in the hygienic education database 11 is based on illness illustrations and diagnosis suggestions made by the different medical doctors for different conditions or orders of severity generated by various illnesses.

The search and comparison unit 12 is connected to the data input unit 10 and the hygienic education database 11 to receive the above diagnostic data and define an illness grade by determining the parameters set by the medical doctor or the regions where the test data are located. The hygienic education database 11 is searched according to the illness grade to list hygienic education information corresponding to the illness grade in the hygienic education database 11.

The search and comparison unit 12 is connected to the hygienic education database 11 via the Internet to render the hygienic education database 11 independent from local services. Thus, the contents of the hygienic education database 11 can be easily expanded to provide more hygienic education information for patients.

The output unit 13 is connected to the search and comparison unit 12, and is used to convert the hygienic education information listed by the search and comparison unit 12 to various file formats, thus providing hygienic education information conveniently for patients needs. The file format can be a document format, a table format, or a multimedia audio/video format. Moreover, the hygienic education information can be provided for patients via the display unit 14, the print unit 15 or the storage unit 16. The display unit 14, the print unit 15 and the storage unit 16 are all connected to the output unit 13 to receive hygienic education information in the respective file formats necessary for displaying, printing and storing. In practical design, the storage unit 16 can be an optical disc recorder, which records to an optical disc the electronic files created from the hygienic education information for convenient access and lookup as a reference for the patient.

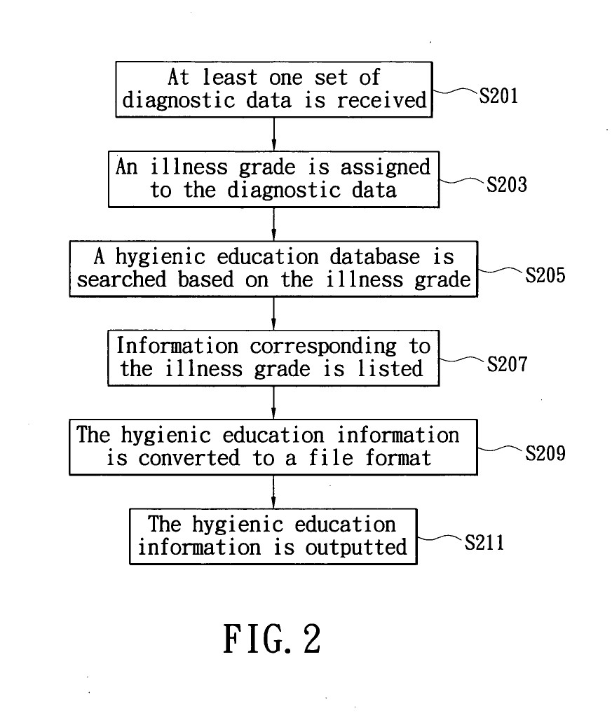

FIG. 2 is a flowchart of a method for providing hygienic education information according to an embodiment of the present invention. As shown in FIG. 2, the present invention provides a method for providing hygienic education information, which comprises the following steps. First, the search and comparison unit 12 receives one set of diagnostic data (Step S201). The diagnostic data can be either a personal diagnosis of a patient's illness condition by a medical doctor and/or a diagnosis made by the doctor based on test data of the patient taken by a medical apparatus. Additional information can be added by a medical doctor in the personal diagnosis of a patient's illness condition to specify different illness or illness grades.

After the search and comparison unit 12 receives the diagnostic data, an illness grade of the diagnostic data is assigned according to the parameters set by the medical doctor and the regions from where the test data originate (Step S203). The hygienic education database 11 is then searched based on the illness grade (Step S205). Finally, hygienic education information corresponding to the illness grade is listed (Step S207).

Besides, in order to conveniently provide hygienic education information for patients, the output unit 13 converts the hygienic education information found by the search and comparison unit 12 to a file format (Step S209). The hygienic education information converted to a file format is outputted in different manners (Step S211). Thereby, patients can get hygienic education information conforming to their own illness conditions for reference and warning.

Diabetes mellitus is taken as the example. The hygienic education database 11 stores hygienic education information relevant to various types of diabetes mellitus. Diabetes mellitus has a variety of manifestations. Although all are accompanied by high blood sugar, they have different pathogenic reasons. Nowadays, diabetes mellitus can generally be classified into the first type diabetes mellitus (insulin-dependent type), the second type diabetes mellitus (non-insulin-dependent type), impaired glucose tolerance type diabetes mellitus, and gestational diabetes mellitus.

When a patient seeks medical advice, the physician can give a diagnosis solely based on a medical examination or in combination with test data, and attach different parameters to the diagnosis result according to the diagnosed type of diabetes mellitus (e.g., the first type diabetes mellitus represented by a parameter A1, the second type diabetes mellitus represented by a parameter A2, and so on) to formalize the diagnostic data. The diagnostic data will contain information such as the medical doctor's diagnosis result (the type of diabetes mellitus), relevant test data, the medical department to which the patient belongs, and so on.

After the system 1 for providing hygienic education information receives the diagnostic data, the parameters based on the patient's illness or the regions where the test data originate can be recognized so as to define an illness grade of the patient in the diagnostic data or specify the medical department to which the patient belongs. Next, the hygienic education database 11 can be searched according to this diagnostic data. According to this embodiment, after the system 1 for providing hygienic education information distinguishes an illness grade of the patient (known from the parameters set by the medical doctor or the regions where the test data are located) and the medical department to which the patient belongs, the system 1 determines that the illness is diabetes mellitus and which type of diabetes mellitus the patient has, and then accurately lists the hygienic education information relevant to that type of diabetes mellitus and to the medical department.

The patient can select to view the hygienic education information on the display unit 14, print the hygienic education information via the print unit 15, or record the hygienic education information onto an optical disc via the storage unit 16. This enables the patient to acquire hygienic education information specifically related to his or her illness in the format most convenient for him/her.

To sum up, through the installation of a hygienic education database and the collection of information from various reports, test data or diagnoses, the present invention can distinguish different diagnoses made by different medical doctors to search the hygienic education database in order to list hygienic education information exactly relevant to the patient's health condition.

Although the present invention has been described with reference to the preferred embodiment thereof, it will be understood that the invention is not limited to the details thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for providing hygienic education information comprising the steps of:
receiving at least one set of diagnostic data;
defining an illness grade of said diagnostic data;
searching a hygienic education database based on the illness grade; and
listing hygienic education information corresponding to said illness grade.

2. The method as claimed in claim 1, wherein said diagnostic data results from a personal medical examination.

3. The method as claimed in claim 2, wherein the definition of an illness grade according to said diagnostic data is performed based on parameters set by the medical doctor.

4. The method as claimed in claim 1, wherein said diagnostic data consists of a patient's test data.

5. The method as claimed in claim 4, wherein the definition of an illness grade from said diagnostic data is performed based on regions where the patient's test data originates.

6. The method as claimed in claim 1, wherein said hygienic education database stores hygienic education information, illness illustrations and diagnosis suggestions according to said illness grade from different medical departments.

7. The method as claimed in claim 1 further comprising the steps of:
converting said listed hygienic education information to various file formats; and
outputting said hygienic education information in the respective file format.

8. The method as claimed in claim 7, wherein said file format is a document format, a table format or a multimedia audio/video format.

9. The method as claimed in claim 7, wherein said hygienic education information is outputted in the respective file format by displaying, printing or storing.

10. A system for providing hygienic education information comprising:
at least one data input unit for receiving at least one set of diagnostic data;
a hygienic education database for storing hygienic education information; and
a search and comparison unit connected to said data input unit and said hygienic education database and used to search said hygienic education database according to an illness grade of said diagnostic data and then list hygienic education information corresponding to the illness grade.

11. The system as claimed in claim 10, wherein said diagnostic data results from a personal examination and/or from patient test data.

12. The system as claimed in claim 10, wherein said data input unit is further connected to a medical report system to receive medical consultation data and/or a test data generated by said medical report system and then convert said consultation data and/or said test data into said diagnostic data.

13. The system as claimed in claim 10, wherein said hygienic education database stores hygienic education information, illness illustrations and diagnosis suggestions according to said illness grade from different medical departments.

14. The system as claimed in claim 10, wherein said search and comparison unit is connected to said hygienic education database via the Internet.

15. The system as claimed in claim 10 further comprising an output unit, wherein said output unit is connected to said search and comparison unit and used to convert said listed hygienic education information to a file format.

16. The system as claimed in claim 15, wherein said file format is a document format, a table format or a multimedia audio/video format.

17. The system as claimed in claim 15, further comprising:
a display unit connected to said output unit and used to receive and display said listed hygienic education information;
a print unit connected to said output unit and used to receive and print said listed hygienic education information; and
a storage unit connected to said output unit and used to receive and store said listed hygienic education information.

18. The system as claimed in claim 17, wherein said storage unit is an optical disc recorder used to record said hygienic education information in a certain file format into an optical disc.
